(19) United States
(12) Patent Application Publication
(10) Pub. No.: US 2024/0354292 A1
(43) Pub. Date: Oct. 24, 2024

(54) SYSTEMS, METHODS, AND APPARATUSES FOR VERIFYING ENTRIES IN DISPARATE DATABASES

(71) Applicant: CDK GLOBAL, LLC, Hoffman Estates, IL (US)

(72) Inventor: Craig Gardner, Portland, OR (US)

(21) Appl. No.: 18/763,320

(22) Filed: Jul. 3, 2024

Related U.S. Application Data
(63) Continuation of application No. 17/237,587, filed on Apr. 22, 2021, now Pat. No. 12,045,212.

(51) Int. Cl. G06F 16/215; G06F 16/178; G06F 16/21; G06F 16/25; G06F 16/27

(52) U.S. Cl. CPC G06F 16/215; G06F 16/1794; G06F 16/214; G06F 16/258; G06F 16/27; G06F 16/273; G06F 16/275; G06F 16/278

(57) ABSTRACT

Embodiments herein relate to replacing a legacy Pick environment with a modern microservice architecture. A legacy database and a modern database may be operated in parallel for data validation. Part of the data validation may include verifying that changes to a business object that are entered on the legacy Pick environment are similarly entered by the modern microservice architecture.

### RELATED APPLICATIONS

This application is a continuation of and claims priority to U.S. patent application Ser. No. 17/237,587, titled SYSTEMS, METHODS, AND APPARATUSES FOR VERIFYING ENTRIES IN DISPARATE DATABASES, and which is incorporate herein by reference in its entirety.

### TECHNICAL FIELD

The present disclosure relates generally to data validation when replacing a database. More specifically, the present disclosure relates to methods, systems and apparatuses for validating entries in a legacy database and a modern database.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of a data system in accordance with one embodiment.

FIG. 2 illustrates a simplified signal flow diagram for a data validation system in accordance with one embodiment.

FIG. 3 illustrates a method for validating data on disparate databases based on data stored on a Pick database in accordance with one embodiment.

FIG. 4 illustrates an aspect of the subject matter in accordance with one embodiment.

### DETAILED DESCRIPTION

Described herein are embodiments of systems, apparatuses, and methods for data validation so that entries in disparate databases (e.g., a legacy database and a modern database) that are operating simultaneously are synchronized.

Businesses occasionally replace and modernize their database environments. Often the move from a legacy database environment to a modern database environment involves moving between two different incompatible data architectures. Additionally, there is often a desire to gradually transition between the legacy database and the modern database to allow for data validation of the modern database while allowing applications to take advantage of the modern database. To provide data validation in some embodiments the two databases may be run in parallel and a validation system may compare updates to records in the legacy database against updates to the modern database. However, because the databases have different data architectures, comparing the updates may be inefficient.

One of the challenges of the transition between databases is handling the different architectures of the systems. To address this challenge, embodiments below include a comparison service that can compare two different databases structured in completely different ways.

Specific embodiments herein relate to replacing a legacy Pick environment with a modern microservice architecture. While movement between a Pick environment and a modern microservice architecture is discussed herein, embodiments herein may also be applied to transitioning between other database types.

The phrases “coupled to,” “connected to,” and “in communication with” refer to any form of interaction between two or more components, including mechanical, electrical, magnetic, and electromagnetic interaction. Two components may be connected to each other, even though they are not in direct contact with each other, and even though there may be intermediary devices between the two components.

It will be readily understood that the components of the embodiments as generally described below and illustrated in the Figures herein could be arranged and designed in a wide variety of different configurations. For instance, the steps of a method do not necessarily need to be executed in any specific order, or even sequentially, nor do the steps need to be executed only once. Thus, the following more detailed description of various embodiments, as described below and represented in the Figures, is not intended to limit the scope of the disclosure but is merely representative of various embodiments. While the various aspects of the embodiments are presented in the drawings, the drawings are not necessarily drawn to scale unless specifically indicated.

Embodiments and implementations of systems and methods described herein may include various steps, which may be embodied in machine-executable instructions to be executed by a computer system. A computer system may include one or more general-purpose or special-purpose computers (or other electronic devices). The computer system may include hardware components that include specific logic for performing the steps or may include a combination of hardware, software, and/or firmware.

Embodiments may be provided as a computer program product including a computer-readable medium having stored thereon instructions that may be used to program a computer system or other electronic device to perform the processes described herein. The computer-readable medium may include, but is not limited to, hard drives, floppy diskettes, optical disks, CD-ROMs, DVD-ROMs, ROMS, RAMS, EPROMS, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or Internet or Internet Protocol (IP) networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell®, Microsoft®, and other vendors, and may operate using Transfer Control Protocol (TCP)/IP, SPX, IPX, and other protocols over twisted pair, coaxial, or optical fiber cables; telephone lines; radio waves; satellites; microwave relays; modulated AC power lines; physical media transfer; and/or other data transmission “wires” known to those of skill in the art. The network may encompass smaller networks and/or be connectable to other networks through a gateway or similar mechanism.

Each computer system includes one or more processors and/or memory; computer systems may also include various input devices and/or output devices. The processor may include a general-purpose device, such as an Intel®, AMD®, or other “off-the-shelf” microprocessor. The processor may include a special-purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, disk, tape, or magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, RAM, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools such as Modern Fortran, Java, Pascal, C++, C, PHP, .Net, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Aspects of certain embodiments may be implemented as software modules or components. As used herein, a software module or component may include any type of computer instruction or computer executable code located within or on a computer-readable storage medium. A software module may, for instance, comprise one or more physical or logical blocks of computer instructions, which may be organized as a routine, program, object, component, data structure, etc., that performs one or more tasks or implements particular abstract data types. A particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media.

Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network. According to one embodiment, a database management system (DBMS) allows users to interact with one or more databases and provides access to the data contained in the databases.

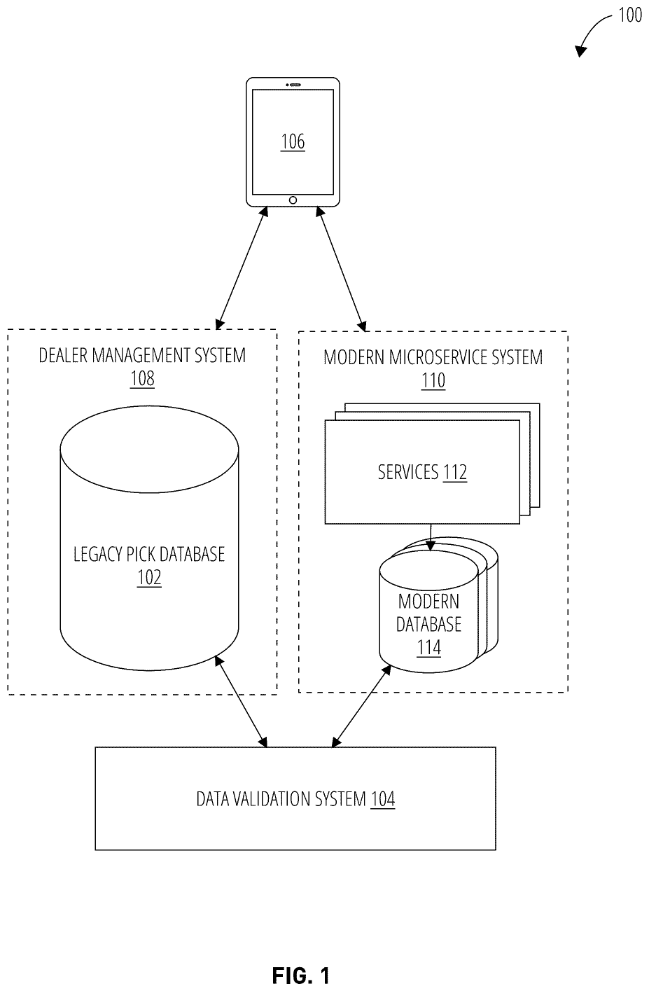

FIG. 1 illustrates a block diagram of a data system 100 transitioning from a dealer management system 108 to a modern microservice system 110. As shown, the data system 100 may operate two databases in parallel during a transition from a legacy database (e.g., dealer management system 108) to a modern database (e.g., modern microservice system 110).

Running the two databases in parallel may allow for a gradual roll out of the new architecture in a way that permits data validation and allows older applications to take advantage of the new environment. For example, an application running on a computing device 106 may have been developed for the legacy dealer management system 108. To upgrade to the modern microservice system 110, it may be desirous to have the application access both the modern microservice system 110 and the dealer management system 108 in parallel and track the changes in the dealer management system 108 in comparison to the modern microservice system 110 to validate that all of the changes to data in the dealer management system 108 are being captured by the modern microservice system 110.

For example, a business may desire to replace a legacy Pick environment (e.g., dealer management system 108) with a modern microservice architecture (e.g., modern microservice system 110). A Pick environment includes an operating system for databases that was developed decades ago. The Pick environment has an architecture with a centralized dealer management system 108 with applications and a legacy Pick database 102. A dealer management system 108 may refer to a stand-alone computer system that hosts the legacy data and code. Each client (i.e., a user of the data system 100) may have at least one dealer management system 108 to host the clients' applications and data. Occasionally a client may have more than one dealer management system 108.

The legacy software and database for the dealer management system 108 may have been developed over a long period of time. As a consequence, there may be a very large amount of messy code, messy database design, and a very large amount of complexity. For example, information corresponding to a specific object (e.g., customer, vendor, financial institution) controlled by the application of the computing device 106 may be spread over several data files. To further complicate matters, the data files may not be homogenous with respect to one object. For example, information corresponding to a customer may be in the same data file as information corresponding to a vendor. This unorganized and complicated set of data files may make it difficult to track changes to each object and make it difficult to compare changes made to the dealer management system 108 and the modern microservice system 110.

In contrast to the organization of the dealer management system 108, the new modern microservice system 110 may have a data architecture that structures an application as a collection of services 112 which stores information on a modern database 114. For example, the application controllable objects that are spread across multiple data files in the data system 100 may be ordered according to independent services 112. This change in data architecture from the dealer management system 108 to the modern microservice system 110 and the complexity of the dealer management system 108 makes data validation difficult and inefficient.

To reduce the complexity and improve efficiency of data validation, a data validation system 104 may track, filter, and compare updates to information corresponding to the objects as discussed in more detail below.

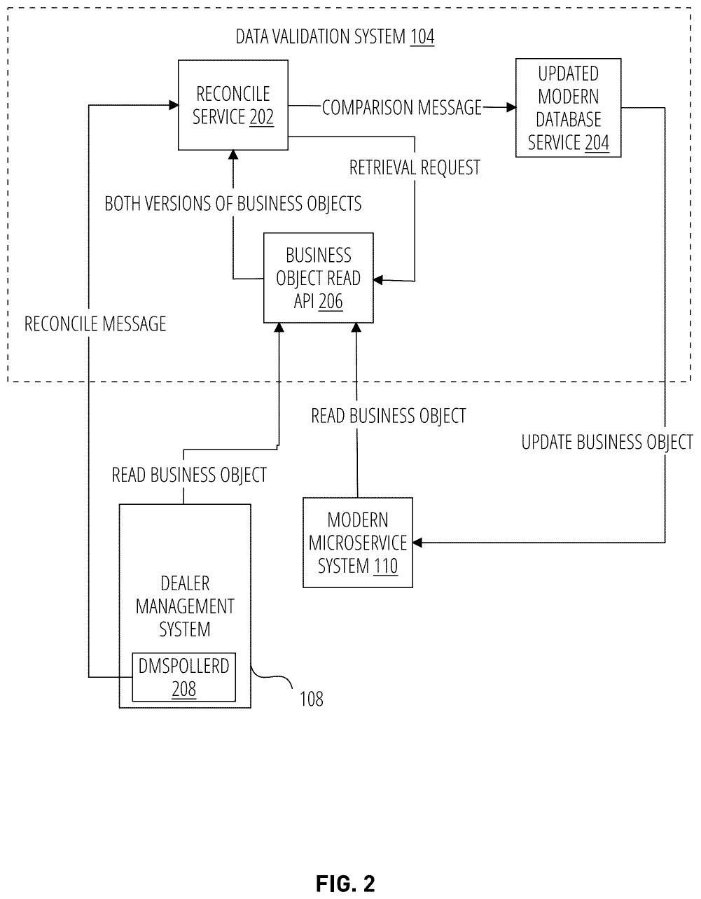

FIG. 2 illustrates a simplified signal flow diagram for a data validation system 104. Replacing legacy code and an associated database (e.g., dealer management system 108) with a new, modern architecture database (e.g., modern microservice system 110) is a large and difficult process. Accordingly, it may be desirous to run the dealer management system 108 and the modern microservice system 110 simultaneously to allow older applications to take advantage of the new environment and ensure proper handling of data during the transition. However, running two databases simultaneously introduces a problem: ensuring that the two databases correctly handle data entries. The data validation system 104 may verify the data in the dealer management system 108 and the modern microservice system 110 even though they are different databases structured completely differently.

In the illustrated embodiment, the dealer management system 108 belongs to a car dealership. However, a similar system may be set up for other types of clients. The dealer management system 108 may comprise a plurality of data files (e.g., name-file, service-names, and customer comments). Each data file may comprise a series of items or records that make up data elements of the data file. As the dealer management system 108 may have been developed and updated for several decades, there may be a large amount of messy code, messy database design, and a very large amount of complexity that makes it difficult to completely replicate the functions of the Pick database on a new database system.

Accordingly, data validation may be desirous. Data validation may include determining that the updates occurring on the dealer management system 108 are also captured on the modern microservice system 110 that is running in parallel. Part of validating the data on the disparate systems involves comparing the data on each database to ensure that it is the same. However, the different data structures of the dealer management system 108 and the modern microservice system 110 may make it difficult to verify the data.

The new data structure may be developed around a plurality of objects. Objects, also referred to herein as business objects, may be a collection of closely related data elements, items, and/or records that represent information that a client business works with. For example, business objects may include customers, vehicles, and vehicle purchase contracts. In contrast, items related to one object may be incorporated into multiple data files on the dealer management system 108.

Additionally, each data file in the dealer management system 108 may include items related to multiple objects or items not related to an object. On the dealer management system 108, items are stored in the data files. A Pick item on the dealer management system 108 may correspond roughly to a record in a modern database. In other words, a Pick item may be described as a document, rather than a record. An example of a non-homogenous file may include a name-file. The name-file may contain most of the customer business object information. However, the name-file may also contains information about other business objects such as Employees, Vendors, Financial Institutions, and more. In some embodiments, a customer item in name-file may also even contain accounts receivable amounts and aging information.

The dealer management system 108 comprises a dmspollerd 208 which may be a daemon or service that runs on the dealer management system 108 and monitors for updates on data files and Pick items related to business objects. The dmspollerd 208 may periodically request the latest updates to Pick files and datafiles on the dealer management system 108. When dmspollerd 208 identifies a change to the dealer management system 108, the dmspollerd 208 may send a notice of the change. The notification may be a reconcile message sent to the reconcile service 202. In some embodiments, the reconcile message may be sent via Kafka.

The reconcile message may comprise the item keys and update time stamp. The item keys may provide an identification for the updated data. For example, the item key may be an identification for a business object associated with the updated data. In some embodiments, the message may look like the following example.

```
  {
  “domain” : “Customer”,
  “enterprise_id” : “E207187”,
  “keys” : [
    {
      “depts” : [ “D100093794” ],
  “id” : “9014”,
  “timestamp” : “1603193254.561832”,
  “type” : “4”
    }
],
    “store_id” : “S100023739”
  }
```

The reconcile service 202 may be listening for the reconcile message. Upon receiving a reconcile message, the reconcile service 202 may request a current version of the data indicated in the reconcile message from both the dealer management system 108 and the modern microservice system 110. For example, in some embodiments, the reconcile service 202 may send a retrieval request to the business object read API 206. The retrieval request may include the item key identifying the business object of interest.

The business object read API 206 may request and read the updated business object, as identified by the item key, from the dealer management system 108. The business object read API 206 may pull Pick data from the dealer management system 108. As the dealer management system 108 is a legacy system, the pulled data may be in a non-standard and unique format. For example, the dealer management system 108 may store data as strings. The business object read API 206 may convert the non-standard format into an external format. For example, the business object read API 206 may convert the data type from strings to an XML format and associate a tag with the data. For instance, the business object read API 206 may convert and label a date to a standard format and convert money to an expected type (e.g., an integer value). The label may provide context to the data. For example, when the information is translated, a tag may be added that identifies the date. For instance, a specific date may be tagged as a customer birthday. In some embodiments, the label and the data may be combined into a data table.

The business object read API 206 may assemble the data in the data table into business objects. In some embodiments, the business object read API 206 may filter entries in the data table to obtain a filtered data set based on the tags. The filtered information may include data associated with tags that identify the information as corresponding with a business object. For example, the business objects may be customer business objects, employee business objects, vendor business objects, and financial institution business objects. If the tags relate to a business object, the business object read API 206 may include it in a filtered data set and exclude irrelevant data.

The data table may be in XML format. For a customer object, the data may include a variety of information about a customer including name, email, telephone number, address, other contact information, birthdate, credit score, customer identification, and driver license information. The XML data table may be a set of rows and columns containing the data. For example, each row of data may include a tag identifying the data followed by columns with the information related to that data. For example, one row may be tagged as email address, and the columns may include one or more email addresses associated with the customer.

The business object read API 206 may restructure the filtered XML data table into a common format. For example, the business object read API 206 may convert the data to a JSON format. Converting to JSON may allow for a more efficient comparison. For example, the conversion from the XML format to JSON may convert a relation like or single row of data to something that looks more like a document. The XML formatted file may have more columns then needed. For example, if there are some customers with five email addresses it will create empty cells for other customers without five email addresses. The JSON format may provide areas that can have as few or as many spaces as needed. Thus limiting the need for mostly empty columns that may be found in the XML formatted file.

The business object read API 206 may also retrieve corresponding data from the modern microservice system 110. That is, the business object read API 206 may request and read the business object from the modern microservice system 110 that corresponds with the business object read from the dealer management system 108. The business object read API 206 may also restructure the business object from the modern microservice system 110 to JSON. By converting objects from both data sources (e.g., dealer management system 108 and modern microservice system 110) to a common JSON format, it may allow a service that does not have knowledge of the type of business object to compare the objects.

The business object read API 206 may send both versions of the business object to the reconcile service 202. The reconcile service 202 compares the objects to determine that they match. For example, the reconcile service 202 may recursively compare the two different JSON-structured business objects to verify that they contain equivalent information. If a data mismatch is discovered, the reconcile service 202 may send a comparison message to the updated modern database service 204. The comparison message may contain a master copy of the business object. In some embodiments, the master copy is the copy obtained from the dealer management system 108. The updated modern database service 204 provides the modern microservice system 110 with an update to the business object if a discrepancy is found.

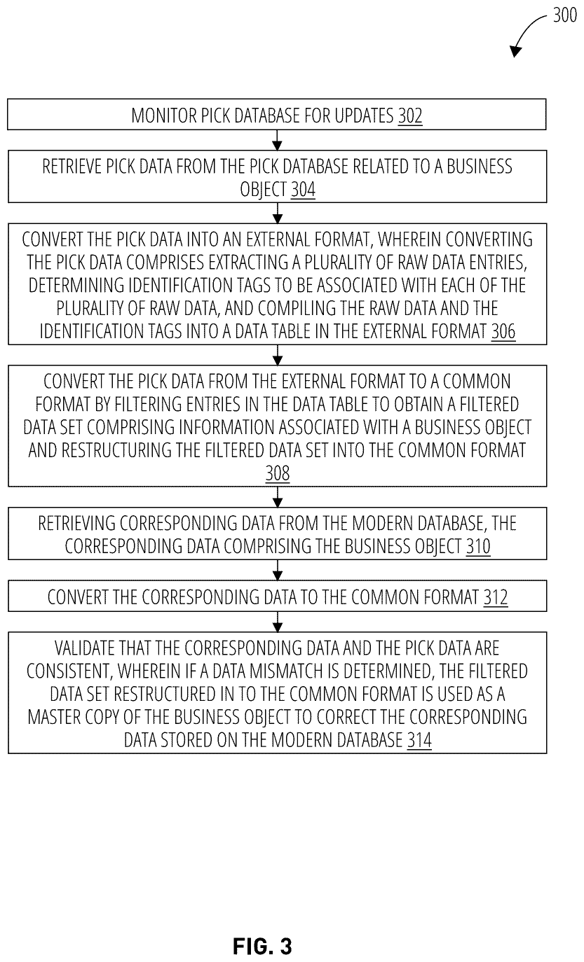

FIG. 3 illustrates a method 300 for validating entries stored on multiple databases in accordance with one embodiment. The method 300 may be performed by a data validation system such as the data validation system 104 in FIG. 1. The multiple databases may include a Pick system and a modern microservice system.

As shown, the system using the method 300 may monitor 302 a Pick database for updates. When the system detects an update, it may retrieve 304 Pick data from the Pick database related to a business object. The system may convert 306 the Pick data into an external format. In some embodiments, converting the Pick data comprises extracting a plurality of raw data entries, determining identification tags to be associated with each of the plurality of raw data, and compiling the raw data and the identification tags into a data table in the external format. The external format may be XML. The system may also convert 308 the Pick data from the external format to a common format by filtering entries in the data table to obtain a filtered data set comprising information associated with a business object and restructuring the filtered data set into the common format. In some embodiments, the common format is JSON.

Similarly, the system may retrieve 310 corresponding data from the modern database. The corresponding data may include a copy of the business object retrieved from the Pick database as stored on the modern database. The system may convert 312 the corresponding data to the common format. The system may validate 314 that the corresponding data and the Pick data are consistent by comparing the entries converted to the common format. If a data mismatch is determined, the filtered data set from the Pick database that has been restructured into the common format may be used as a master copy of the business object to correct the corresponding data stored on the modern database. In some embodiments, the system may send a message identifying the correction to be made. In other embodiments, the system may format a business object according to the structure of the modern database and send the entire business object.

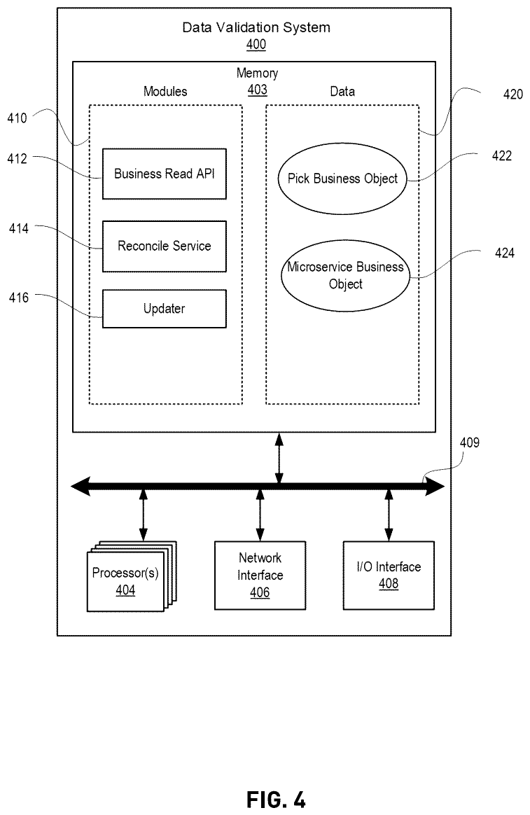

FIG. 4 is a block diagram of a data validation system 400 according to one embodiment. The data validation system 400 may perform the methods and use the techniques described with reference to the other Figures in the specification. The data validation system 400 can include a memory 403, one or more processors 404, a network interface 406, an input/output interface 408, and a system bus 409.

The one or more processors 404 may include one or more general-purpose devices such as an Intel®, AMD®, or other standard microprocessor. The one or more processors 404 may include a special-purpose processing device such as ASIC, SoC, SiP, FPGA, PAL, PLA, FPLA, PLD, or other customized or programmable device. The one or more processors 404 can perform distributed (e.g., parallel) processing to execute or otherwise implement functionalities of the presently disclosed embodiments. The one or more processors 404 may run a standard operating system and perform standard operating system functions. It is recognized that any standard operating systems may be used such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The memory 403 may include static RAM, dynamic RAM, flash memory, one or more flip-flops, ROM, CD-ROM, DVD, disk, tape, or magnetic, optical, or other computer storage medium. The memory 403 may include a plurality of program modules 410 and program data 420. The memory 403 may be local to the data validation system 400, as shown, or may be distributed and/or remote relative to the data validation system 400.

Data generated or used by the data validation system 400, such as by the program modules 410 or other modules, may be stored on the memory 403, for example, as stored program data 420. The program data 420 may be organized as one or more databases. The program data 420 may include Pick business object 422 and a corresponding microservice business object 424. The Pick business object 422 may comprise a business object obtained from a Pick database. The microservice business object 424 may include a business object obtained from a modern database system and correspond to the Pick business object 422.

The program modules 410 may run multiple operations concurrently or in parallel by or on the one or more processors 404. In some embodiments, portions of the disclosed modules, components, and/or facilities are embodied as executable instructions embodied in hardware or firmware, or stored on a non-transitory, machine-readable storage medium. The executable instructions may comprise computer program code that, when executed by a processor and/or computing device, causes a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to, circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, subsystems, and/or the like.

The program modules 410 may comprise a business read API 412, a reconcile service 414, and an updater 416. The business read API 412 may receive corresponding business objects from two disparate databases and convert the business objects into a common format. The reconcile service 414 may compare the two business objects to determine if there are discrepancies. If a discrepancy is found, the updater 416 may update the modern database based on the record of the legacy database.

The input/output interface 408 may facilitate user interaction with one or more input devices and/or one or more output devices. The input device(s) may include a keyboard, mouse, touchscreen, light pen, tablet, microphone, sensor, or other hardware with accompanying firmware and/or software. The output device(s) may include a monitor or other display, printer, speech or text synthesizer, switch, signal line, or other hardware with accompanying firmware and/or software. For example, in one embodiment, the input/output interface 408 comprises a display to provide a graphical user interface (GUI) illustrating the potential ablation perimeters. The input/output interface 408 can receive user input data. In some embodiments, the input/output interface 408 is a touchscreen, and the size input is received via the touchscreen. In some embodiments, the input/output interface 408 can superimpose the target ablation perimeters on an image of the tissue.

The network interface 406 may facilitate communication with other computing devices and/or networks and/or other computing and/or communications networks. The network interface 406 may be equipped with conventional network connectivity such as, for example, Ethernet (IEEE 1102.3), Token Ring (IEEE 1102.5), Fiber Distributed Datalink Interface (FDDI), or Asynchronous Transfer Mode (ATM). Further, the network interface 406 may be configured to support a variety of network protocols such as, for example, IP, TCP, Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 409 may facilitate communication and/or interaction between the other components of the data validation system 400, including the one or more processors 404, the memory 403, the input/output interface 408, and the network interface 406.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

While specific embodiments of stents have been illustrated and described, it is to be understood that the disclosure provided is not limited to the precise configuration and components disclosed. Various modifications, changes, and variations apparent to those of skill in the art having the benefit of this disclosure may be made in the arrangement, operation, and details of the methods and systems disclosed, with the aid of the present disclosure.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill, having the benefit of this disclosure, in the art that changes may be made to the details of the above-described embodiments without departing from the underlying principles of the disclosure herein.

What is claimed is:

1. A method for validating data on disparate databases based on data stored on a Pick database, the method comprising:
operating a Pick database and a modern database, in parallel;
retrieving, in response to receiving an update to a business object at the Pick database, Pick data from the Pick database related to the business object;
converting the Pick data into an external format by extracting a plurality of raw data entries, determining identification tags to be associated with each of the plurality of raw data, and compiling the raw data and the identification tags into a data table in the external format;
converting the Pick data from the external format to a common format by filtering entries in the data table to obtain a filtered data set comprising information associated with a business object and restructuring the filtered data set into the common format;
retrieving corresponding data from the modern database comprising the business object;
converting the corresponding data to the common format;
comparing the Pick data in the common format to the corresponding data in the common format; and
validating that the corresponding data and the Pick data are consistent by determining that the Pick database business object and the corresponding data business object contain equivalent information, wherein if a data mismatch is determined between the Pick database business object and the corresponding data business object, sending a comparison message to the modern database to update the corresponding data business object using a master copy of the Pick database business object to correct the corresponding data stored on the modern database.

2. The method of claim 1, wherein the common format is JSON and the external format is XML.

3. The method of claim 1, further comprising monitoring the Pick database for updates to a plurality of business objects.

4. The method of claim 3, wherein when an update occurs, a message with a key indicating which business object the update is associated with is generated.

5. The method of claim 1, wherein the business object comprises one of a customer business object, an employee business object, a vendor business object, and a financial institution business object.

6. The method of claim 1, wherein the Pick database is part of a centralized dealer management system.

7. The method of claim 1, wherein the modern database is a modern microservice architecture.

8. The method of claim 1, wherein the Pick database has a first database architecture and the modern database has a second database architecture different from the first database structure.

9. The method of claim 8, wherein the Pick database, having the first database architecture, corresponds to a dealer management system, and the modern database, having the second database architecture, corresponds to a modern microservice.

10. A non-transitory computer-readable storage medium, the computer-readable storage medium including instructions that when executed by a computer, cause the computer to:
retrieve, in response to receiving an update to a business object at a Pick database, Pick data from the Pick database related to the business object;
convert the Pick data into an external format, wherein converting the Pick data comprises extracting a plurality of raw data entries, determining identification tags to be associated with each of the plurality of raw data, and compiling the raw data and the identification tags into a data table in the external format;
convert the Pick data from the external format to a common format by filtering entries in the data table to obtain a filtered data set comprising information associated with a business object and restructuring the filtered data set into the common format;
retrieve corresponding data from a modern database, the corresponding data comprising the business object;
convert the corresponding data to the common format; and
validate that the corresponding data and the Pick data are consistent by determining that the Pick database business object and the corresponding data business object contain equivalent information, wherein if a data mismatch is determined between the Pick database business object and the corresponding data business object, send a comparison message to the modern database to update the corresponding data business object using a master copy of the Pick database business object to correct the corresponding data stored on the modern database.

11. The non-transitory computer-readable storage medium of claim 8, wherein the common format is JSON and the external format is XML.

12. The non-transitory computer-readable storage medium of claim 8, wherein the instructions further configure the computer to monitor the Pick database for updates to a plurality of business objects.

13. The non-transitory computer-readable storage medium of claim 10, wherein when an update occurs, a message with a key indicating which business object the update is associated with is generated.

14. The non-transitory computer-readable storage medium of claim 8, wherein the business object comprises one of a customer business object, an employee business object, a vendor business object, and a financial institution business object.

15. The non-transitory computer-readable storage medium of claim 8, wherein the Pick database is part of a centralized dealer management system.

16. The non-transitory computer-readable storage medium of claim 8, wherein the modern database is a modern microservice architecture.

17. The non-transitory computer-readable storage medium of claim 10, wherein the Pick database has a first database architecture and the modern database has a second database architecture different from the first database structure.

18. The non-transitory computer-readable storage medium of claim 17, wherein the Pick database, having the first database architecture, corresponds to a dealer management system, and the modern database, having the second database architecture, corresponds to a modern microservice.

19. A computing apparatus comprising:
a processor; and
a memory storing instructions that, when executed by the processor, configure the apparatus to:
retrieve, in response to receiving an update to a business object at a Pick database, Pick data from the Pick database related to the business object;
convert the Pick data into an external format, wherein converting the Pick data comprises extracting a plurality of raw data entries, determining identification tags to be associated with each of the plurality of raw data, and compiling the raw data and the identification tags into a data table in the external format;
convert the Pick data from the external format to a common format by filtering entries in the data table to obtain a filtered data set comprising information associated with a business object and restructuring the filtered data set into the common format;
retrieve corresponding data from a modern database, the corresponding data comprising the business object;
convert the corresponding data to the common format; and
validate that the corresponding data and the Pick data are consistent by determining that the Pick database business object and the corresponding data business object contain equivalent information, wherein if a data mismatch is determined between the Pick database business object and the corresponding data business object, send a comparison message to the modern database to update the corresponding data business object using a master copy of the Pick database business object to correct the corresponding data stored on the modern database.

20. The computing apparatus of claim 15, wherein the common format is JSON and the external format is XML.

21. The computing apparatus of claim 15, wherein the instructions further configure the apparatus to monitor the Pick database for updates to a plurality of business objects.

22. The computing apparatus of claim 17, wherein when an update occurs, a message with a key indicating which business object the update is associated with is generated.

23. The computing apparatus of claim 15, wherein the business object comprises one of a customer business object, an employee business object, a vendor business object, and a financial institution business object.

24. The computing apparatus of claim 15, wherein the Pick database is part of a centralized dealer management system and the modern database is a modern microservice architecture.

25. The computing apparatus of claim 19, wherein the Pick database has a first database architecture and the modern database has a second database architecture different from the first database structure.

26. The computing apparatus of claim 25, wherein the Pick database, having the first database architecture, corresponds to a dealer management system, and the modern database, having the second database architecture, corresponds to a modern microservice.
